(19) United States
(12) Patent Application Publication
(10) Pub. No.: US 2015/0088772 A1
(43) Pub. Date: Mar. 26, 2015

(54) ENHANCING IT SERVICE MANAGEMENT ONTOLOGY USING CROWDSOURCING

(71) Applicant: International Business Machines Corporation, Armonk, NY (US)

(72) Inventors: Larisa Shwartz, Scarsdale, NY (US); Maja Vukovic, New York, NY (US)

(73) Assignee: International Business Machines Corporation, Armonk, NY (US)

(21) Appl. No.: 14/037,062

(22) Filed: Sep. 25, 2013

(51) Int. Cl. G06Q 50/00; G06Q 10/06

(52) U.S. Cl. CPC G06Q 50/01; G06Q 10/063
USPC 705/319

(57) ABSTRACT

A computer implemented method performs an IT service management operation such as analyzing a problem, associated with an entity configuration in a domain having an ontology, wherein each entity has relationships with other entities. Information provided by the ontology is used to create a specified question pertaining to the operation. It is then determined whether an answer to the question is initially available. Responsive to an answer being initially available, information provided by the initially available answer and the ontology, selectively, is used to create a second question, wherein the second question pertains to the operation and is directed to one of the entities. Responsive to an answer to the specified question not being initially available, a crowdsourcing technique is used to seek an answer to the specified question.

### BACKGROUND

1. Field

The invention disclosed and claimed herein generally pertains to a method and system for performing an operation in a computer related system or other environment associated with Information Technology (IT) service management. More particularly, the invention pertains to a method and system of the above type for performing IT service different types of management operations, by using a related ontology and a crowdsourcing technique.

2. Description of the Related Art

In an IT service environment, subject matter experts (SMEs) involved in service management or related activities frequently do not follow known best practices, when determining the cause of a problem, or carrying out other operations. This may occur because SMEs lack sufficient time to follow through in carrying out a proper analysis in a specific context. Some SMEs may also lack the discipline to make such an analysis.

An IT service environment as described above typically comprises a configuration of entities, also referred to as classes or concepts, wherein there are relationships between pairs of entities. An ontology maps the domain of the environment, and represents the relationships between respective entity pairs. However, an ontology design generally requires multiple iterations and refinements, and it is often not known beforehand how the domain will evolve. Also, encoding ontology domains can require inputs from multiple experts. In the past, these characteristics have tended to direct away from using ontology in IT operations or activities, such as resolving an IT service management problem.

### SUMMARY

Embodiments of the invention provide a method and system that systematically guides and executes an operation pertaining to IT service management, wherein related questions are created by basing the questions on an IT service management ontology. Embodiments can also guide a process of IT service management ontology refinement, by specifying a set of tasks that may be crowdsourced to domain SMEs. This process can result in discovering gaps in the ontology. Moreover, the crowdsourcing, or engagement of experts, can be automated as part of the effort to use the IT service management ontology to systematically carry out the operation. IT service management operations, as used herein, can include processes such as problem analysis and problem resolution. IT service management operations can further include backup management; network management; incident management; release management; and service level agreement management. However the invention is not limited thereto.

One embodiment of the invention is directed to a computer implemented method for performing an IT operation associated with a configuration of entities, which are respectively included in a specified domain having a first ontology, wherein each entity has a relationship with each of one or more other entities. The method comprises the step of using information provided by the first ontology to create a specified question pertaining to the operation. The method further comprises determining whether an answer to the specified question is initially available. Responsive to an answer to the specified question being initially available, information provided by the initially available answer, and by the first ontology, selectively, is used to create a second question, wherein the second question pertains to the operation and is directed to at least one of the entities. Responsive to an answer to the specified question not being initially available, a crowdsourcing procedure is implemented to seek an answer to the specified question.

### BRIEF DESCRIPTION

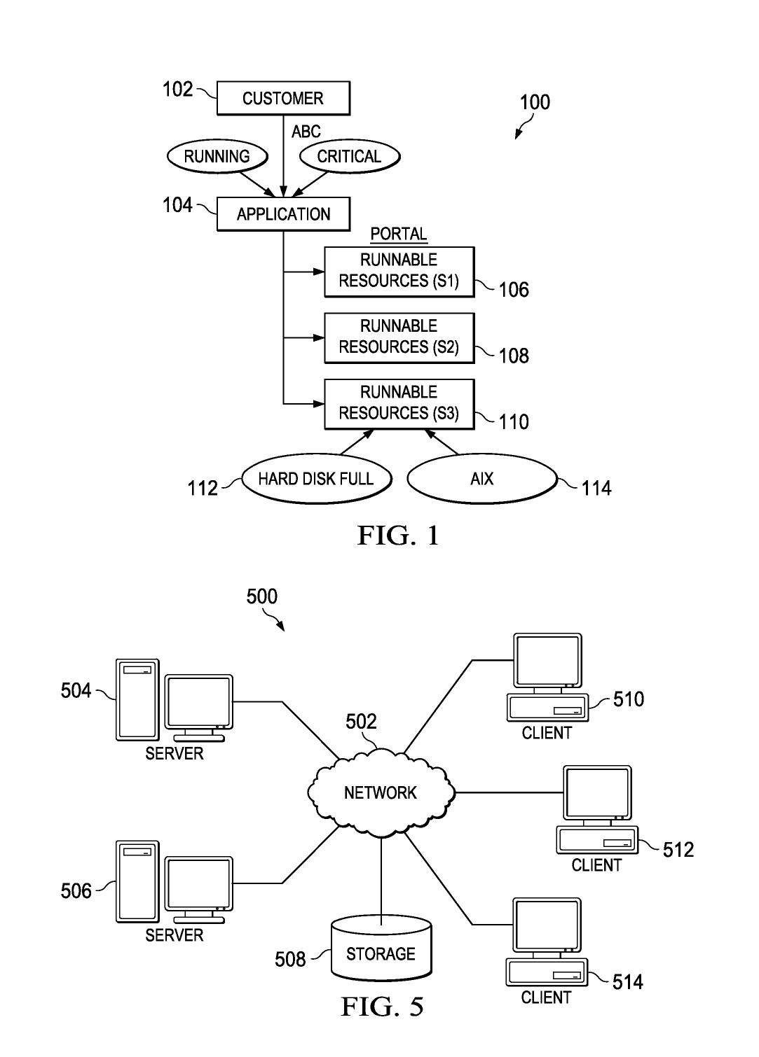

FIG. 1 is a schematic diagram showing a configuration of computer related resources and other entities, which has an ontology that may be used in illustrating an embodiment of the invention.

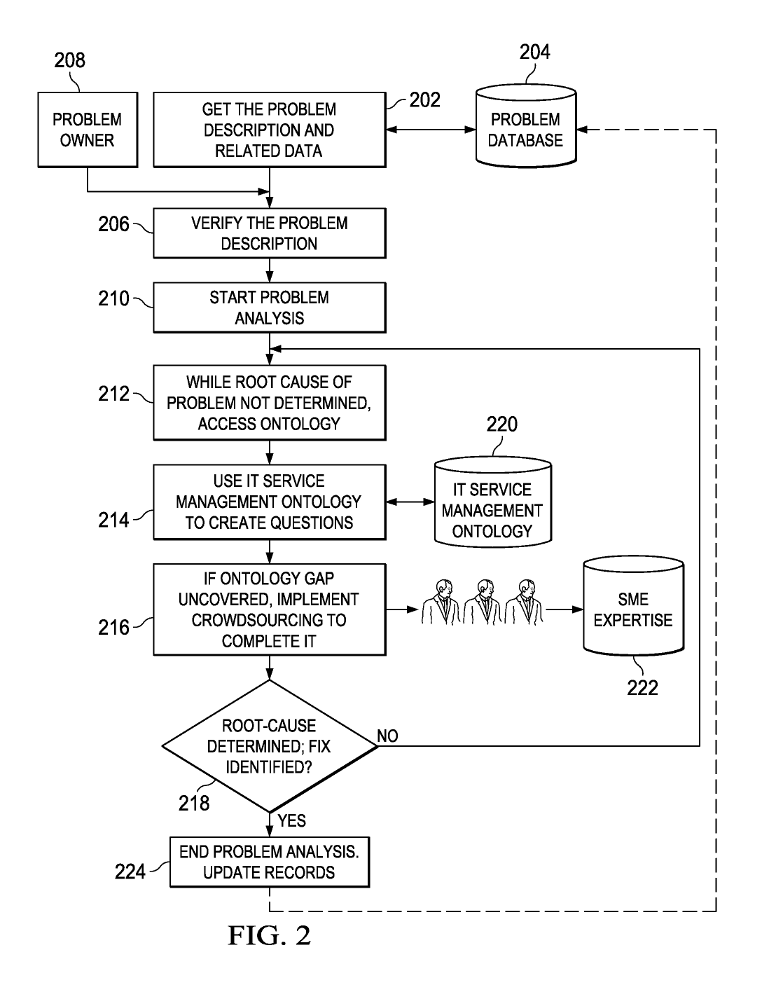

FIG. 2 is a flowchart that illustrates elements and features of an embodiment of the invention.

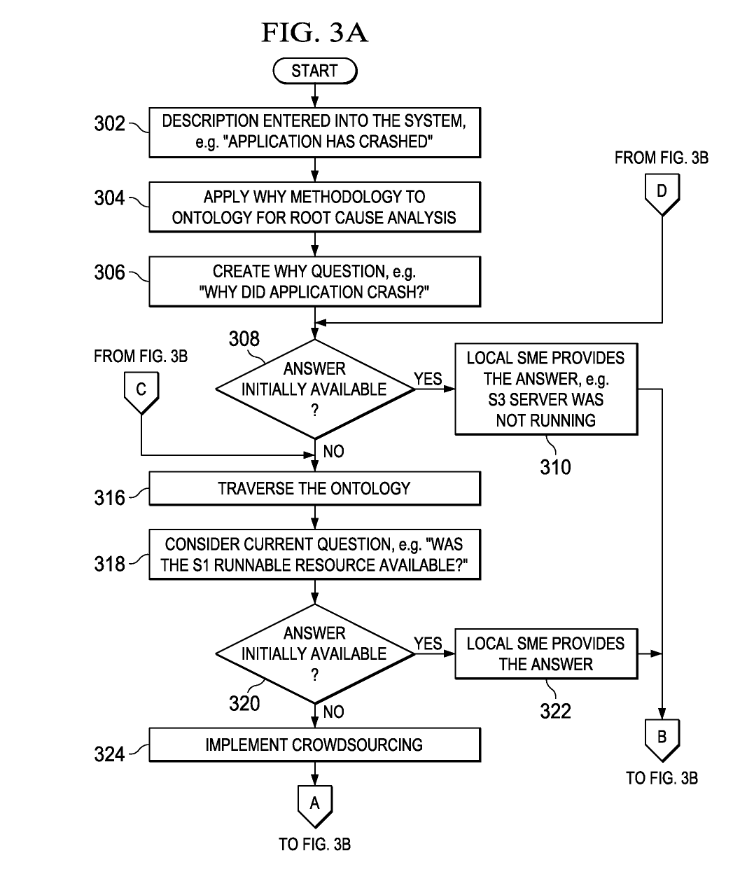

FIGS. 3A-3B are a flowcharts showing a further embodiment of the invention.

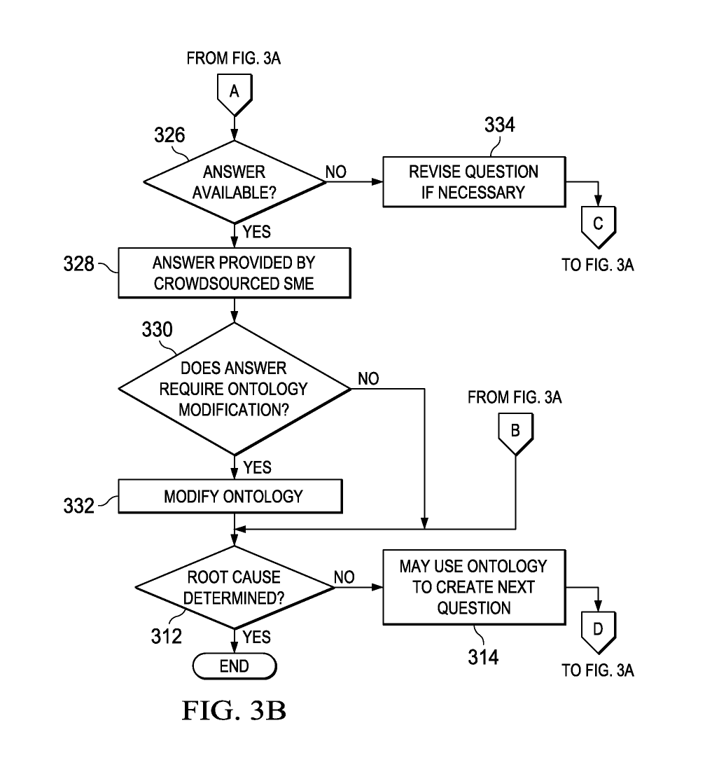

FIG. 4A-4B are flowcharts that respectively illustrate use of the embodiment of FIG. 3 in connection with an operation comprising a simplified exemplary problem.

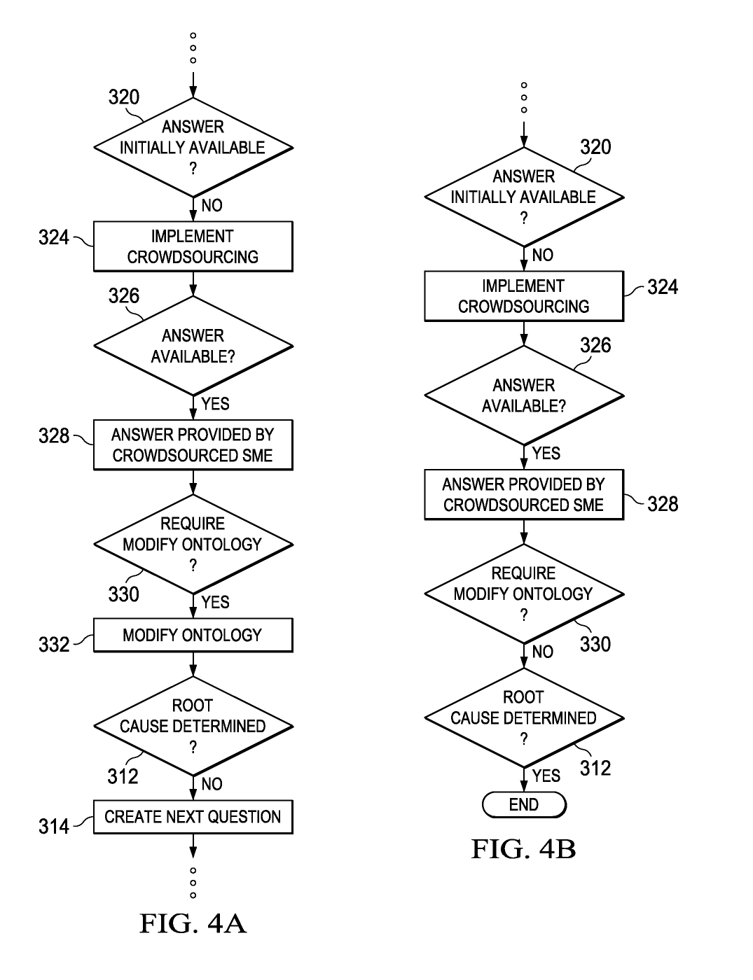

FIG. 5 is a block diagram showing a network of data processing systems in which an embodiment of the invention may be implemented.

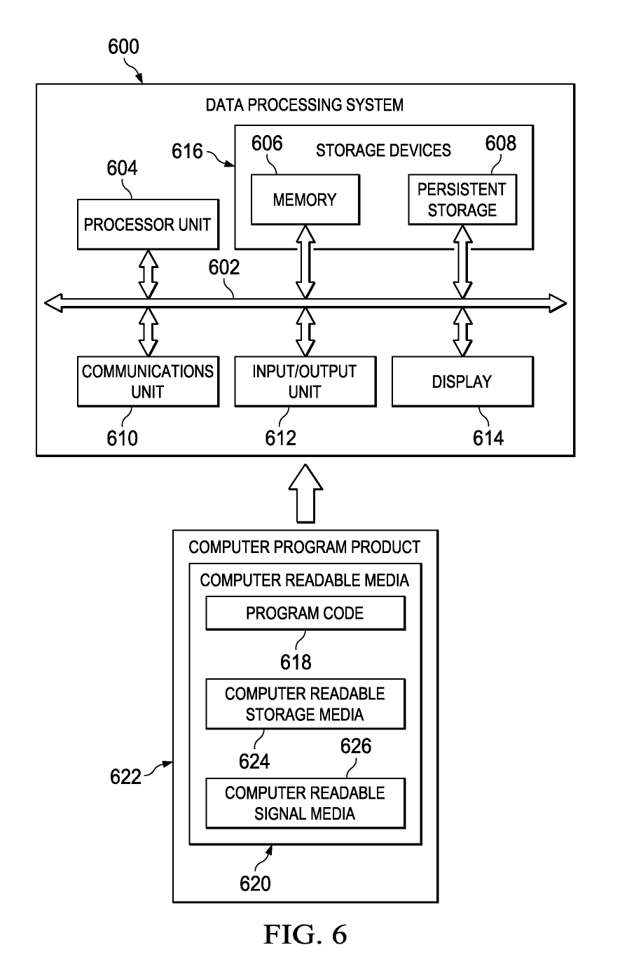

FIG. 6 is a block diagram showing a computer or data processing system that may be used in implementing embodiments of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring to FIG. 1, there is shown a configuration of entities 100, which has an ontology as described above associated with it, and is usefully located in an IT service management environment or the like. Configuration 100 includes entities that comprise computer related resources and devices, but may also include entities comprising humans or human resources. Configuration 100 is provided for use in illustrating a simplified exemplary embodiment of the invention.

FIG. 1 indicates that configuration 100 more particularly shows that a customer 102, such as the ABC Corporation, uses an application 104 in its business, wherein the application has been provided by a supplier. Application 104 has both a running state and a critical state. When application 104 is running, the application may access runnable resources 106-110 through a portal. Each of the resources 106-110 comprises a server, a data store or other device, or some combination thereof and can include both hardware and software components. Resources 106-110 are also referenced as S1-S3, respectively. FIG. 1 further shows that resource 110 has an associated hard disk 112 and an operating system 114.

In accordance with embodiments of the invention, it is necessary to consider the ontology that represents all entities of the domain defined by configuration 100, including computer related resources and also human resources. The ontology is intended to capture both infrastructure and process oriented types of elements and characteristics. As described above, the entities of configuration 100 usefully pertain to an IT service management activity or environment. In this environment, a service provider usefully operates a delivery center to provide support and IT outsourcing services to customers. For such environment, the associated ontology would include details about each customer, such as the services offered to that customer, the pertinent service portfolio, runtime dependencies, and related hardware. Also of interest would be the service level agreement with each customer.

Referring to FIG. 2, there is shown a flowchart illustrating significant elements and features of a method comprising an embodiment of the invention. This embodiment is directed to the IT service management operation of analyzing a problem, in order to determine its cause. However, while problem analysis and resolution are important types of IT service management operations, this embodiment is provided only as an example, and the invention is by no means limited thereto. Principles illustrated by the exemplary embodiment could readily be used with other embodiments of the invention, which respectively pertain to other types of IT service management operations as described above.

At step 202, the method acquires a particular problem, such as a problem that has been detected in the environment of entities configuration 100 described above. A complete description of the problem, as well as related data, may be obtained from a problem database 204.

At step 206 the description of the particular problem is verified, by a problem owner 208. This step is provided to ensure that the particular problem is clearly defined, by one having a significant interest in problem resolution. An exemplary problem could be a resource server that doesn't work, or the problem could be that application 104 has crashed. The problem owner 208 by way of example could be the computer system administrator, or other representative of a system that has a component affected by the particular problem. Analysis of the problem is started at step 210.

Steps 212-218 of FIG. 2 together provide an iterative loop or cycle. More specifically, these steps act collectively to drive toward a determination of the root cause of the particular problem. At step 212, when the root cause of the problem is not known, the ontology associated with the problem is accessed, by one who is tasked to fix or resolve the problem. This could be an administrator or other user at a service delivery center of the type referred to above. For the configuration of entities 100 in the above described environment, the ontology would be an IT service management ontology. FIG. 2 shows this ontology being accessed from a database 220 or the like.

At step 214 a user makes use of information from the ontology to iteratively create questions that are pertinent to possible causes of the problem. Usefully, the questions are created in accordance with the Five Whys technique, although embodiments of the invention are by no means limited thereto. As is known by those of skill in the art, the Five Whys is an iterative question asking technique used to explore the cause and effect relationships underlying a particular problem, wherein the goal of the technique is to determine the root cause of a defect or problem. Generally, the Five Whys approach first asks why an event A occurred. The response is that an event B occurred, which caused the event A. The Five Whys technique then asks why the event B occurred, as a second question. This process continues until a string of five questions has been asked, which typically provides a great deal of information about the initial event A.

By providing a set of rules and an array of selectively structured data, such as an ontology of the type described above, a system can be constructed that automatically generates questions using the Five Whys technique, starting with a problem having some association with the ontology. Moreover, as further described above, an ontology has entities, and also has relationships between pairs of entities. In view of this, the ontology can readily be used to write or create questions, by using a noun that pertains to an entity, and a verb derived from a relationship which includes that entity. Exemplary questions of the type created at step 214 are set forth hereinafter, in connection with FIGS. 3 and 4A-4b.

In accordance with embodiments of the invention, it has been recognized that as questions are created at step 214 to seek answers, it is likely that gaps in the ontology, or the absence of important pieces of information from the ontology, will be discovered. When this occurs, the method of FIG. 2 may implement a procedure to complete or fill in the gap. For a particular task or knowledge requirement, this could be carried out by seeking an expert from an expert database 222, which contains a listing of SMEs who meet the particular requirement. Database 222 could include expert skills, ratings, reviews, and/or contributions to past and/or current projects. If necessary, database 222 could also be used to engage a team of SMEs. Moreover, other crowdsourcing techniques and approaches as are known in the art, in addition to or as an alternate to database 222, may be used to implement crowdsourcing at step 216 of FIG. 2.

Decision step 218 determines whether or not the root cause of a problem has been determined, so that the root cause can be fixed. If not, the method returns to step 212, and otherwise proceeds to step 224, to end the problem analysis. Step 224 also updates records in the problem database 204.

Referring to FIG. 3, there is shown a flowchart depicting a method comprising a further embodiment of the invention. As described above in connection with FIG. 2, embodiments of the invention use the ontology associated with an operation comprising a problem, together with an analysis tool such as the Five Whys technique, to search for a root cause of the problem. Moreover, a crowdsourcing procedure of some type is implemented when a gap is detected in the ontology, in order to provide information that is useful or essential for the root cause analysis. FIG. 3 describes aspects and features of FIG. 2 in further detail. In addition, the method of FIG. 3 provides an approach for discovering or recognizing gaps in the ontology, which may trigger or invoke crowdsourcing.

At step 302, the method of FIG. 3 commences when a specific problem description is entered. By way of example and not limitation, the initially specified problem is that application 104 of configuration 100 has crashed. At step 304, the Five Whys methodology described above is applied to this problem, to create the question “Why did the application crash?” at step 306.

Following step 306, the method of FIG. 3 provides a decision step 308, which determines whether or not an answer to the question of 306 is initially available. Such an answer would provide a cause of or reason for the specific problem set forth by the question of step 306. In the embodiment of FIG. 3, and for all other purposes of this application, an answer is initially available at step 308, if the answer is immediately available at step 308 or step 320, or if the answer can be provided by an SME who is directly involved with or immediately responsible for resolving the specific problem. For example, the SME could be a system administrator or other employee located at a service delivery center as described above, which was associated with entity configuration 100 and application 104, and was responsible for providing service support. Herein, SMEs of this type are referred to as “local SMEs” or “resident SMEs.”

If decision step 308 provides a positive result, the method of FIG. 3 proceeds to step 310, where the local SME provides the initially available answer. By way of example the answer, which comprises the cause of the application crash, is shown to be that the server resource S3 was not running. The method then goes to decision step 312, which determines whether an answer received at step 312 shows a root cause of the original problem stated at step 302.

If the determination at step 312 is positive the method of FIG. 3 ends, and otherwise proceeds to step 314. At this step, the ontology may be used to create the next question to be addressed by the method. As an example, for the answer stated at step 310, step 314 could be implemented to use the ontology to generate the question “why was the S3 server not running?” From the ontology of the S3 server, subsequent questions could be created that addressed structural and/or process elements of the S3 server in increasing detail. For example, the root cause could be related to an element or feature of the hard disk or the operating system of the S3 server. Thus, the method of FIG. 3 successively moves toward determining the root cause of the original problem, so that the root cause can be fixed and avoided in the future.

It is to be emphasized that creation of questions at step 314 takes into account, and is based on, both the ontology and all previous user actions and responses in connection with the method of FIG. 3. Following creation of a question at step 314, the method returns to the input of decision step 308.

If the answer to any question created at step 306 or step 314 is not initially available as defined above at decision step 308, the method goes to step 316. At this step, the ontology is usefully traversed, to provide a user with helpful insights or further information in regard to the most recent question to be created. As is known by those of skill in the art, it is common practice to traverse an ontology from left to right, and then move downward. At step 318, which follows step 316, the most current or recent question is considered. As an example, FIG. 3 shows this question directed to whether the S1 runnable resource was available.

Step 318 is followed by a decision step 320, which determines whether or not an answer to the question of step 318 is initially available. In like manner with step 308 described above, if decision step 320 furnishes a positive result, the method of FIG. 3 proceeds to step 322, and a local SME provides the answer. The local SME may or may not be the same local SME as at step 310. After step 322, the method proceeds to decision step 312, and then either ends or goes on to step 314.

It will be appreciated, from the above description of FIG. 3, that a negative result provided by decision step 320 indicates that a local SME was not able to provide an answer to the current question at step 310. Moreover, after traversing the ontology for assistance at step 316, a local SME was still unable to answer the question. In accordance with the embodiment of FIG. 3, these events are considered to strongly infer that there is a gap in the ontology. Therefore, the method of FIG. 3 proceeds to step 324, to implement crowdsourcing.

Crowdsourcing may be implemented at step 324 using one of a number of techniques or approaches that are well known to those of skill in the art. In one useful technique, one or a set of tasks are specified that pertain to the current question and to the ontology. These tasks are then used to determine the skills and knowledge that an expert will need to have, in order to be considered for crowdsourcing. Qualified crowdsourcing experts or SMEs are then selected, such as from database 222 described above, and the current question is sent to one or more of those experts. The question may be accompanied by a request for additional information, or for answers to additional questions.

In specifying tasks for implementing crowdsourcing at step 324, some or all of the following matters and topics could be used:
What is the Domain that the ontology will cover?
For what will the ontology be used?
For what types of questions should the information in the ontology
provide answers?
Who will use and maintain the ontology?
Enumerate exemplary terms
Top down & bottom up—classes and subclasses
Define properties of classes—slots
   Intrinsic
   Extrinsic
Define slot cardinality, type
Domain and a range of slots
Create instances
Define class
Transitivity
Evolution of hierarchy
Check for class cycles and tasks
Analyze siblings
Verify multiple inheritance
A new class vs. property value.
An instance or a class
Disjoint classes/subclasses
Inverse slots

It is anticipated that the crowdsourcing implementation procedure of step 324 could be an automated procedure, either entirely or in part. Also, the above topics and matters could be used in automatically constructing a crowdsourcing request or solicitation. For example, pertinent ones of these matters and topics could be selected, and used to construct a questionnaire that is sent to crowdsourcing experts.

It is anticipated further that some of the tasks at step 324 will be tasks that seek to extend the ontology. Such ontology extension tasks could include, by way of example and not limitation, the following:
1. Define/verify ontology class
2. Define/verify class instance
3. Define/verify class cardinality (e.g. number of classes) or slots (e.g. unique elements or properties of class)
4. Define/verify class siblings
5. Define/verify class inheritance
6. Define/verify class extension
7. Define/verify disjoint classes
8. Define/verify relationship between class instances

FIG. 3 further shows that the crowdsourcing implementation at step 324 is followed by a decision step 326. This step determines whether or not the question sent out for crowdsourcing at step 324 has been answered by one or more of the crowdsourced SMEs to which it was sent. If the decision of step 326 is affirmative the method of FIG. 3 proceeds to step 328, and otherwise goes to step 334. The crowdsourced answered is provided by the SME at step 328.

Following step 328, decision step 330 determines whether the ontology needs to be modified. For example, when the crowdsourced SME responded to the question, she or he could have furnished a relevant concept or value that previously was not found in the ontology. The ontology would then need to be modified in order to include this new information, and accordingly proceeds to step 332. Thereafter, the method goes to step 312. If the decision at step 330 is negative, the method would go directly to step 312.

Referring further to FIG. 3, it is seen that the method thereof reaches step 334 only if decision step 326 has not received an answer to the question which was previously crowdsourced, at step 324. This failure to receive an answer from any of the crowdsourced SMEs could be a further basis for concluding that there was a gap in the ontology. Also, it may be necessary to revise the previously presented question. This action is taken at step 334. The method of FIG. 3 then returns to step 316, and carries out another iteration of steps 316-326.

Referring to FIGS. 4A and 4B, there are shown certain sequences of steps of the method of FIG. 3, to further illustrate the embodiment thereof. More particularly, FIG. 4A shows a sequence of steps 320-314, after a number of iterations of the steps 308 and 316-326, as described above, have already taken place. As a result of those iterations, it has been determined that the application crashed because the sever resource S3 was not running. Moreover, in carrying out an analysis to determine why the server S3 was not running, by generating successive questions, the last question created at step 314 was the query “Did the configuration of entities 100 include any non-standard specification”?

Referring further to FIG. 4A, decision step 320 determines that an answer to this question is not initially available. Accordingly, an answer is sought by implementing crowdsourcing at step 324. Decision step 326 determines that the crowdsourcing effort is successful, and an answer to the question is provided at step 328. More specifically, a crowdsourced SME was aware that a certain standard specification, for a configuration of the type to which configuration 100 belongs, was that an application 104 needed to provide at least 100 transactions of a particular kind per minute. However, the crowdsourced SME was also aware a special provision in the agreement for configuration 100 specified that application 104 was to be able to provide 101,000 transactions of the particular kind per minute.

In response to the above answer, it is determined at step 330 of FIG. 4A that the ontology of configuration 100 needs to be modified, in accordance with information provided by the answer. This is carried out at step 332, and the method proceeds to decision step 312. Step 312 determines that a root cause of the original problem has not yet been found, and the method goes to step 314. This step creates the next question, which is “does the specification of 1000 transactions per minute affect the operation of server S3, when application 104 is running on such server?”

Referring to FIG. 4B, the question created at step 314 of FIG. 4A is considered at decision step 320 of FIG. 4B. It is determined that an answer to this question is not initially available, and the method proceeds to crowdsource the question at step 324. Step 326 indicates that an answer is available from a crowdsourced SME, and the answer is provided at step 328. The answer discloses that running application 104 on server S3 in an effort to achieve 1000 transactions of the particular kind per minute can cause the application to crash.

At decision step 330 of FIG. 4, it is determined that information provided by this answer does not require further modification of the ontology. At step 312, it is concluded that a root cause of the original problem has now been determined, and the method ends.

FIG. 5 is a pictorial representation of a network of data processing systems in which illustrative embodiments of the invention may be implemented. Network data processing system 500 is a network of computers in which the illustrative embodiments may be implemented. Network data processing system 500 contains network 502, which is the medium used to provide communications links between various devices and computers connected together within network data processing system 500. Network 502 may include connections, such as wire, wireless communication links, or fiber optic cables.

In the depicted example, server computer 504 and server computer 506 connect to network 502 along with storage unit 508. In addition, client computers 510, 512, and 514 connect to network 502. Client computers 510, 512, and 514 may be, for example, personal computers or network computers. In the depicted example, server computer 504 provides information, such as boot files, operating system images, and applications to client computers 510, 512, and 514. Client computers 510, 512, and 514 are clients to server computer 504 in this example. Network data processing system 500 may include additional server computers, client computers, and other devices not shown.

Program code located in network data processing system 500 may be stored on a computer-recordable storage medium and downloaded to a data processing system or other device for use. For example, program code may be stored on a computer-recordable storage medium on server computer 504 and downloaded to client computer 510 over network 502 for use on client computer 510.

In the depicted example, network data processing system 500 is the Internet with network 502 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 500 also may be implemented as a number of different types of networks, such as, for example, an intranet, a local area network (LAN), or a wide area network (WAN). FIG. 5 is intended as an example, and not as an architectural limitation for the different illustrative embodiments.

Turning now to FIG. 6, an illustration of a data processing system is depicted in accordance with an illustrative embodiment. In this illustrative example, data processing system 600 includes communications fabric 602, which provides communications between processor unit 604, memory 606, persistent storage 608, communications unit 610, input/output (I/O) unit 612, and display 614.

Processor unit 604 serves to process instructions for software that may be loaded into memory 606. Processor unit 604 may be a number of processors, a multi-processor core, or some other type of processor, depending on the particular implementation. “A number,” as used herein with reference to an item, means one or more items. Further, processor unit 604 may be implemented using a number of heterogeneous processor systems in which a main processor is present with secondary processors on a single chip. As another illustrative example, processor unit 604 may be a symmetric multi-processor system containing multiple processors of the same type.

Memory 606 and persistent storage 608 are examples of storage devices 616. A storage device is any piece of hardware that is capable of storing information, such as, for example, without limitation, data, program code in functional form, and/or other suitable information either on a temporary basis and/or a permanent basis. Storage devices 616 may also be referred to as computer readable storage devices in these examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these examples, provides for communications with other data processing systems or devices. In these examples, communications unit 610 is a network interface card. Communications unit 610 may provide communications through the use of either or both physical and wireless communications links.

Input/output unit 612 allows for input and output of data with other devices that may be connected to data processing system 600. For example, input/output unit 612 may provide a connection for user input through a keyboard, a mouse, and/or some other suitable input device. Further, input/output unit 612 may send output to a printer. Display 614 provides a mechanism to display information to a user.

Instructions for the operating system, applications, and/or programs may be located in storage devices 616, which are in communication with processor unit 604 through communications fabric 602. In these illustrative examples, the instructions are in a functional form on persistent storage 608. These instructions may be loaded into memory 606 for processing by processor unit 604. The processes of the different embodiments may be performed by processor unit 604 using computer-implemented instructions, which may be located in a memory, such as memory 606.

These instructions are referred to as program code, computer usable program code, or computer readable program code that may be read and processed by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to data processing system 600 for processing by processor unit 604. Program code 618 and computer readable media 620 form computer program product 622 in these examples. In one example, computer readable media 620 may be computer readable storage media 624 or computer readable signal media 626.

Computer readable storage media 624 may include, for example, an optical or magnetic disk that is inserted or placed into a drive or other device that is part of persistent storage 608 for transfer onto a storage device, such as a hard drive, that is part of persistent storage 608. Computer readable storage media 624 also may take the form of a persistent storage, such as a hard drive, a thumb drive, or a flash memory, that is connected to data processing system 600.

In some instances, computer readable storage media 624 may not be removable from data processing system 600. In these examples, computer readable storage media 624 is a physical or tangible storage device used to store program code 618 rather than a medium that propagates or transmits program code 618. Computer readable storage media 624 is also referred to as a computer readable tangible storage device or a computer readable physical storage device. In other words, computer readable storage media 624 is media that can be touched by a person.

Alternatively, program code 618 may be transferred to data processing system 600 using computer readable signal media 626. Computer readable signal media 626 may be, for example, a propagated data signal containing program code 618. For example, computer readable signal media 626 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 618 may be downloaded over a network to persistent storage 608 from another device or data processing system through computer readable signal media 626 for use within data processing system 600. For instance, program code stored in a computer readable storage medium in a server data processing system may be downloaded over a network from the server to data processing system 600. The data processing system providing program code 618 may be a server computer, a client computer, a remote data processing system, or some other device capable of storing and transmitting program code 618. For example, program code stored in the computer readable storage medium in data processing system 600 may be downloaded over a network from the remote data processing system to the computer readable storage medium in data processing system 600. Additionally, program code stored in the computer readable storage medium in the server computer may be downloaded over the network from the server computer to a computer readable storage medium in the remote data processing system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. In a configuration of entities, which are respectively included in a specified domain having a first ontology, wherein each entity has a relationship with each of one or more other entities, a computer implemented method for performing an Information Technology (IT) service management operation associated with the configuration comprising the steps of:
using information provided by the first ontology to create a specified question pertaining to the operation;
determining whether an answer to the specified question is initially available;
responsive to an answer to the specified question being initially available, using information provided by the initially available answer, and by the first ontology, selectively, to create a second question, wherein the second question pertains to the operation and is directed to at least one of the entities; and
responsive to an answer to the specified question not being initially available, implementing a crowdsourcing procedure to seek an answer to the specified question.

2. The method of claim 1, wherein:
specified information is received in connection with an answer provided by a crowdsourcing procedure, and the specified information is used to selectively modify the first ontology.

3. The method of claim 1, wherein:
responsive to implementing a crowdsourcing procedure, using information pertaining to one or more entities of the configuration, and information pertaining to one or more ontologies related to the specified domain, selectively, to select one or more subject matter experts (SMEs) for the crowdsourcing procedure.

4. The method of claim 1, wherein:
implementation of a crowdsourcing procedure includes automatic determination of SMEs to be used for the crowdsourcing procedure.

5. The method of claim 1, wherein:
implementation of a crowdsourcing procedure includes automatically generating a questionnaire to be sent to one or more SMEs.

6. The method of claim 1, wherein:
a crowdsourcing a procedure is implemented in response to determining that there is a gap in the first ontology.

7. The method of claim 1, wherein:
the specified question is included in an iteratively generated succession of questions, wherein a given question in the succession, that is immediately preceded by another question, is created using information provided by an answer to the immediately preceding question, and by an ontology pertaining to the specified domain, selectively.

8. The method of claim 7, wherein:
the operation comprises an analysis of a problem, and the answer to the last question of the succession specifies a root cause of the problem being analyzed.

9. The method of claim 8, wherein:
the succession of questions are generated in connection with a specified analysis technique, which is used to determine a root cause of the problem being analyzed.

10. The method of claim 9, wherein:
the specified analysis technique comprises the Five Whys technique.

11. The method of claim 1, wherein:
an SME selectively traverses the specified ontology, in order to determine an answer to the specified question.

12. The method of claim 1, wherein:
an inability to obtain an answer to the specified question indicates a gap in the first ontology.

13. In a configuration of entities, which are respectively included in a specified domain having a first ontology, wherein each entity has a relationship with each of one or more other entities, a computer program product executable in recordable storage medium for performing an Information Technology (IT) service management operation associated with the configuration, comprising:
instructions for using information provided by the first ontology to create a specified question pertaining to the operation;
instructions for determining whether an answer to the specified question is initially available;
instructions responsive to an answer to the specified question being initially available, for using information provided by the initially available answer, and by the first ontology, selectively, to create a second question, wherein the second question pertains to the operation and is directed to at least one of the entities; and
instructions responsive to an answer to the specified question not being initially available, for implementing a crowdsourcing procedure to seek an answer to the specified question.

14. The computer program product of claim 13, wherein:
specified information is received in connection with an answer provided by a crowdsourcing procedure, and the specified information is used to selectively modify the first ontology.

15. The computer program product of claim 13, wherein:
responsive to implementing a crowdsourcing procedure, using information pertaining to one or more entities of the configuration, and one or more information pertaining to ontologies related to the specified domain, selectively, to select one or more subject manner experts (SMEs) for the crowdsourcing procedure.

16. The method of claim 13, wherein:
implementation of a crowdsourcing procedure includes automatic determination of SMEs to be used for the crowdsourcing procedure.

17. The computer program product of claim 13, wherein:
the specified question is included in an iteratively generated succession of questions, wherein a given question in the succession, that is immediately preceded by another question, is created using information provided by an answer to the immediately preceding question, and by an ontology pertaining to the specified domain, selectively.

18. The computer program product of claim 17, wherein:
the operation comprises an analysis of a problem, and the answer to the last question of the succession specifies a root cause of the associated problem being analyzed.

19. The computer program product of claim 18, wherein:
the succession of questions are generated in connection with a specified analysis technique, which is used to determine a root cause of the problem being analyzed.

20. In a configuration of entities, which are respectively included in a specified domain having a first ontology, wherein each entity has a relationship with each of one or more other entities, a computer system for performing an Information Technology (IT) service management operation associated with the configuration comprising:
a bus;
a memory connected to the bus, wherein program code is stored on the memory; and
a processor unit connected to the bus, wherein the processor unit executes the program code:
to use information provided by the first ontology to create a specified question pertaining to the operation;
to determine whether an answer to the specified question is initially available;
responsive to an answer to the specified question being initially available to use information provided by the initially available answer, and by the first ontology, selectively, to create a second question, wherein the second question pertains to the operation and is directed to at least one of the entities; and
responsive to an answer to the specified question not being initially available, to implement a crowdsourcing procedure to seek an answer to the specified question.
